(19) United States
(12) Patent Application Publication
(10) Pub. No.: US 2026/0103001 A1
(43) Pub. Date: Apr. 16, 2026

(54) INKJET CHIP STRUCTURE

(71) Applicant: Microjet Technology Co., Ltd., Hsinchu (TW)

(72) Inventors: Hao-Jan Mou, Hsinchu (TW); Cheng-Ming Chang, Hsinchu (TW); Wen-Hsiung Liao, Hsinchu (TW)

(73) Assignee: Microjet Technology Co., Ltd., Hsinchu (TW)

(21) Appl. No.: 19/310,036

(22) Filed: Aug. 26, 2025

(30) Foreign Application Priority Data
Oct. 16, 2024 (TW) 113139355

(51) Int. Cl. B41J 2/14

(52) U.S. Cl. CPC B41J 2/14129; B41J 2/14072; B41J 2/1408; B41J 2/1433

(57) ABSTRACT

The present disclosure provides an inkjet chip structure. The inkjet chip includes an inkjet chip and a nozzle plate. The nozzle plate is disposed on the inkjet chip. The inkjet chip comprises a plurality of ink supply holes, a plurality of first control pads, a plurality of second control pads, and a plurality of ink droplet generators. The ink supply holes are used to supply ink. The plurality of first control pads and the plurality of second control pads are disposed on the inkjet chip for receiving inkjet control signals and power signals, respectively. An area of the plurality of second control pads is equal to or greater than twice of an area of the plurality of first control pads. The ink droplet generators are corresponding to multiple color types, and the number of the ink droplet generators corresponding to each color is greater than or equal to 600.

### CROSS-REFERENCE TO RELATED APPLICATION

This application claims priority to Taiwan Patent Application No. 113139355, filed on Oct. 16, 2024. The entire contents of the above-mentioned patent application are incorporated herein by reference for all purposes.

### FIELD OF THE INVENTION

The present disclosure relates to an inkjet chip structure, and more particularly to an inkjet chip structure having a single inkjet chip with optimized control pads, which can withstand a larger power supply current, thereby achieving stable printing quality and cost competitiveness.

### BACKGROUND OF THE INVENTION

Inkjet printing technology, often referred to as “Inkjet Printing”, is a widely used printing technology. The history of inkjet printing with its origins tracking back to the 1950s when the British component of HP (Hewlett-Packard) invented inkjet printing technology. Since then, the inkjet printing technology has developed rapidly, and the inkjet printers have become the mainstream technology for home and commercial printing. The inkjet printers have many advantages, such as the cost-effectiveness, especially for home and small business use. Also, the inkjet printers have high printing quality, and can provide high-resolution and high-quality images, especially in photos or pictures. Furthermore, the inkjet printers are convenient to use and easy to install, most of inkjet printers can print through computers or mobile devices. In addition, the combination of the inkjet printers and a business machines with all-in-one functions (including fax, photocopying, and scanning) that have emerged in recent years can quickly expand the flexibility of paperwork in the office.

Currently, the application of inkjet printing technology is becoming more and more diverse. From traditional inkjet printers used in in schools and offices to 3D printers or industrial printers that print on various surfaces (such as printing labels), various types of inkjet chips are required to achieve optimized printing results. For example, U.S. Pat. No. 9,016,836 B2 recites an ink jet printhead with polarity-changing driver for thermal resistors. In FIG. 3 of '836 patent, an ink chip is disclosed and includes a stacked structure formed by the protective layer 52, the resistive layer 44, the thermal resistors 26 and the dielectric layers 48, 50, etc. In '836 patent, ink flows upward from the lower layer of the inkjet chip through an ink flow channel and passes through the above-mentioned stack structure and then flows into the ink supply chamber 20 for printing supply, so that traditional inkjet printing technology can achieve the purpose of printing high resolution and high quality images.

However, the inkjet chip of the prior art still has some drawbacks. Generally speaking, since the inkjet chip based on the principle of heating ink has heating requirements, the current of the control pads (IC Pad) of the inkjet chip related to the power supply is very large. Therefore, if the size of the control pads is not large enough to withstand the required current, the circuit may burn out, causing danger or shortening the service life of the inkjet chip, or causing power instability, thereby affecting the actual printing quality.

### SUMMARY OF THE INVENTION

It is an object of the present disclosure to provide an inkjet chip structure. By optimizing the size of the control pads of the inkjet chip related to the power supply, it can better withstand the high current required for printing, thereby providing a safer printing environment and preventing the circuit from burning. Meanwhile, the service life of the inkjet chip structure is extended and the printing quality is improved. In that, the current industry demand for high-resolution and high-quality printing can be met, thereby meeting various office, commercial and industrial uses, and achieving the above-mentioned purpose of the present disclosure. The detailed technical features are described hereafter.

In accordance with an aspect of the present disclosure, an inkjet chip structure is provided and includes an inkjet chip and a nozzle plate. The nozzle plate is disposed on the inkjet chip. The inkjet chip comprises a plurality of ink supply holes, a plurality of first control pads, a plurality of second control pads, and a plurality of ink droplet generators. Wherein, the ink supply holes are used to supply ink. The plurality of first control pads and the plurality of second control pads are disposed on the inkjet chip for receiving inkjet control signals and power signals, respectively. An area of the plurality of second control pads is equal to or greater than twice of an area of the plurality of first control pads. The plurality of ink droplet generators have n types, which are corresponding to different colors in the inkjet chip, and the number of the plurality of ink droplet generators corresponding to each color is greater than or equal to 600. That is to say, if there are three colors, which means there are three types of ink droplet generators, so n=3, and the total number of the plurality of ink droplet generators is greater than or equal to 1800. In another embodiment, if there are four colors, since there are 600 ink droplet generators for each color, the total number of the plurality of ink droplet generators is greater than or equal to 2400.

In the inkjet chip structure according to an embodiment of the present disclosure, the ink droplet generators includes a chip substrate, a thermal barrier layer, a heating resistance layer, a conductive layer, a protective layer and a barrier layer, which are stacked sequentially to form a stacked structure, wherein an ink chamber is formed between the protective layer and the barrier layer, and an ink outlet is formed at the top of the ink chamber, and is in fluid communication with the nozzle aperture.

In the inkjet chip structure according to an embodiment of the present disclosure, the thermal barrier layer is an insulation material formed on the chip substrate. The heating resistance layer is a resistor material formed on the thermal barrier layer. The conductive layer is made of a conductive material. A portion of the conductive layer is formed on the heating resistance layer. A portion of the protective layer is formed on the heating resistance layer, and the other potion of the protective layer is formed on the conductive layer. The barrier layer is a polymer material formed on the protective layer. In addition, an ink chamber and an ink outlet are integrally formed in the barrier layer. The ink flows from an ink supply channel arranged on a side of the ink chamber in a direction parallel to the plane of the stacked structure.

### BRIEF DESCRIPTION OF THE DRAWING

The following detailed descriptions of the present disclosure and the schematic diagrams of the embodiments should enable the present disclosure to be more fully understood. However, it should be understood that this is only used as a reference for understanding the application of the present disclosure, rather than limiting the present disclosure to a specific embodiment.

FIG. 1 is a structural schematic diagram illustrating an inkjet chip structure of the present disclosure;

FIG. 2A is a structural schematic diagram illustrating a stacked structure of the inkjet chip structure of the present disclosure in a lateral view;

FIG. 2B is a structural schematic diagram illustrating the stacked structure of the inkjet chip structure of the present disclosure in a lateral view, wherein the nozzle plate is omitted; and

FIG. 3 illustrates the connection manner between an ink supply channel and a plurality of ink droplet generators of the present disclosure.

### DETAILED DESCRIPTION OF THE PREFERRED EMBODIMENT

The present disclosure will be described in detail with preferred embodiments and viewpoints. The following descriptions provide the specific implementation details of the present disclosure, so that how these embodiments are implemented can be fully understood. One skilled in the art will appreciate that the present disclosure may be practiced without these specific details. In addition, the present disclosure may also be used and implemented through other specific embodiments. The details described in the specification may also be applied based on different needs, and various modifications or changes may be made without departing from the spirit of the present disclosure. Therefore, the present disclosure will now be described more specifically with reference to the following embodiments. It is to be noted that the following descriptions of preferred embodiments of this invention are presented herein for purpose of illustration and description only. It is not intended to be exhaustive or limited to the precise embodiments disclosed. The terminology used in the following descriptions is to be interpreted in the broadest reasonable manner to enable it to be used in conjunction with the detailed description of a particular embodiment of the present disclosure. In that, those skilled in the art can easily understand the relevant description after reading the descriptions of the present disclosure and comparing it with the corresponding drawings, which is explained here in advance.

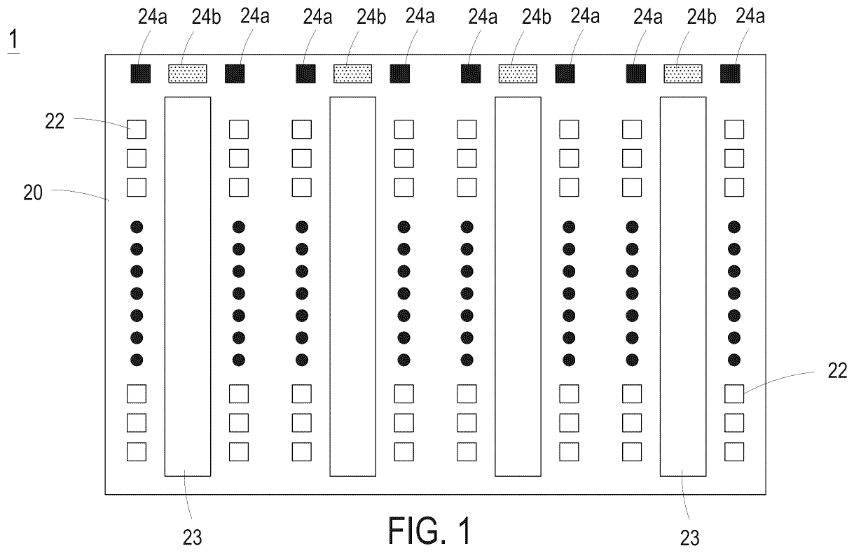

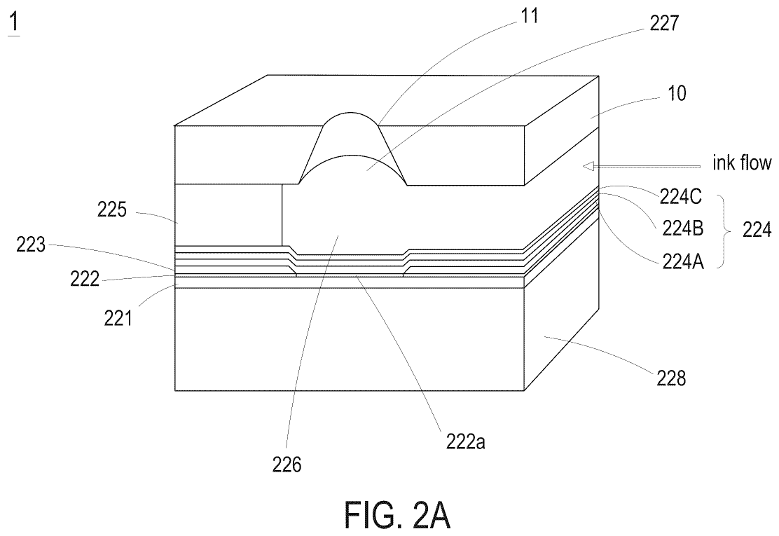

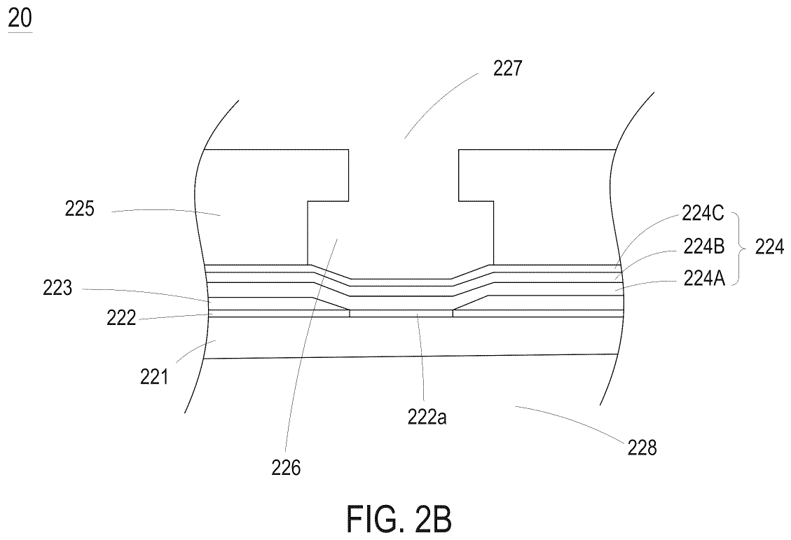

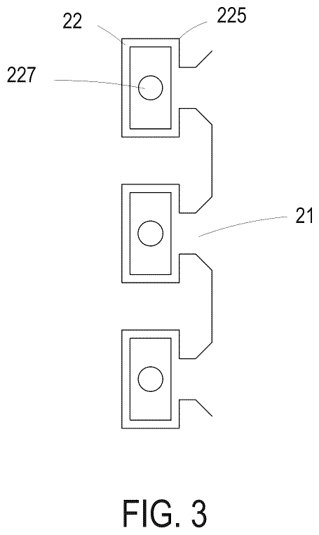

Please refer to FIG. 1, FIG. 2A, FIG. 2B and FIG. 3. In an embodiment of the present disclosure, in order to achieve the above-mentioned purpose of improving printing performances, an inkjet chip structure 1 is provided and includes an inkjet chip 20 and a nozzle plate 10. The nozzle plate 10 is disposed on the inkjet chip 20. Wherein, the inkjet chip 20 includes a plurality of ink supply holes 23, a plurality of first control pads 24a, a plurality of second control pads 24b, and a plurality of ink droplet generators 22. The ink supply holes 23 are used to supply ink. The plurality of first control pads 24a and the plurality of second control pads 24b are disposed on the inkjet chip 20 for receiving inkjet control signals and power signals from external sources, respectively. In the embodiment, an area of the plurality of second control pads 24b is equal to or greater than twice of an area of the plurality of first control pads 24a. Notably, the plurality of ink droplet generators 22 have n types, which are corresponding to different colors in the inkjet chip 20, and the number of the plurality of ink droplet generators 22 corresponding to each color is greater than or equal to 600. That is to say, in the embodiment, if there are three colors, which means there are three types of ink droplet generators 22, so n=3, and the total number of the plurality of ink droplet generators 22 is greater than or equal to 1800. In another embodiment, if there are four colors, since there are 600 ink droplet generators 22 for each color, the total number of the plurality of ink droplet generators 22 is greater than or equal to 2400. According to one aspect of the present disclosure, the size and area relationship between the first control pads 24a and the second control pads 24b is optimized. The first control pads 24a are primarily used to transmit the inkjet control signals from an external terminal, and the second control pads 24b transmit the power signals related to the power supply. In that, the second control pads 24b can better withstand the high current required for printing, thereby providing a safer printing environment and preventing the circuit from burning. Meanwhile, the service life of the inkjet chip structure 1 is extended, and the printing quality is also improved. Consequently, the demand of high-resolution and high-quality printing of current industry is achieved. In addition, according to another aspect of the present disclosure, since the inkjet chip structure 1 integrates multiple colors, it can be manufactured through a photomask including the nozzle plate 10, the inkjet chip 20, and all structures in the ink droplet generators 22. In the embodiment, only one set of processes is required for the inter-layer and final packaging and wiring process. Accordingly, a single ink cartridge is produced that can be used independently. Consequently, there is no need to use more than two sets of different color ink cartridges as the conventional inkjet printers, which results in more than two sets of photomasks required in the manufactory process of the conventional inkjet chips. Hence, the overall cost of the inkjet chip structure 1 of the present disclosure can be greatly reduced. According to another aspect of the present disclosure, snice the inkjet chip structure 1 has more than 600 ink droplet generators 22 for each color, the resolution required for inkjet printing can also be substantially improved. Preferably but not exclusively, in the embodiment, the inkjet chip structure 1 is allowed to print at a resolution (Dots Per Inch, the number of dots or ink drops per inch) ranged from 150 DPI to 48000 DPI, so as to meet the future market's mainstream demand for fine patterns and rich colors.

Please refer to FIG. 2A and FIG. 2B. FIG. 2A is a structural schematic diagram illustrating a stacked structure of the inkjet chip structure of the present disclosure in a lateral view. FIG. 2B is a structural schematic diagram illustrating the stacked structure of the inkjet chip structure of the present disclosure in a lateral view, wherein the nozzle plate is omitted. As shown in FIG. 2A, the inkjet chip structure 1 includes an inkjet chip 20 and a nozzle plate 10. FIG. 2B is a lateral view diagram formed by slightly rotating FIG. 2A. As shown in FIG. 2A and FIG. 2B, the plurality of ink droplet generators 22 of the inkjet chip 20 further includes a chip substrate 228, a thermal barrier layer 221, a heating resistance layer 222, a conductive layer 223, a protective layer 224, and a barrier layer 225, which are stacked sequentially to form a stacked structure, and the position of each nozzle hole 11 corresponds to the corresponding ink droplet generator 22. According to an embodiment of the present disclosure, the chip substrate 228 can be manufactured through a 3 to 20 inch wafer semiconductor process. In the embodiment, the thermal barrier layer 221 is an insulation material formed on the chip substrate 228. The heating resistance layer 222 is a resistor material formed on the thermal barrier layer 221. The heating resistance layer 222 includes a plurality of heating resistors 222a. The conductive layer 223 is made of a conductive material, and a portion of the conductive layer 223 is formed on the heating resistance layer 222. Preferably but not exclusively, a portion of the protective layer 224 is formed on the heating resistor 222a of the heating resistance layer 222. As shown in FIG. 2A, an ink chamber 26 is formed between the protective layer 224 and the barrier layer 225, and an ink outlet 227 is formed at the top of the ink chamber 26, and is in fluid communication with the nozzle aperture 11. In addition, the other potion of the protective layer 224 is formed on the conductive layer 223. The barrier layer 225 is a polymer material formed on the protective layer 224. The ink chamber 226 and the ink outlet 227 are integrally formed in the barrier layer 225. As shown in FIG. 2A and FIG. 3, the ink flows from an ink supply channel 21 arranged on a side of the ink chamber 226 in a direction parallel to the plane of the stacked structure, so as to reduce the flow path of the ink during supply and increase the speed of the ink during supply. Preferably but not exclusively, the ink flow direction shown in FIG. 2A is parallel to the plane of the stacking structure, illustrating an implementation method of supplying ink from the side of the ink chamber 226. As shown in FIG. 3, the ink of each ink droplet generator 22 is provided through the lateral supply of the ink supply channel 21, so that the ink passes through the ink outlet 227 and is finally ejected from the nozzle aperture 11 of the nozzle plate 10.

According to an embodiment of the present disclosure, the nozzle plate 10 can be but not limited to be made of polyimide (PI).

According to an embodiment of the present disclosure, the thermal barrier layer 221 is an insulation material formed on the chip substrate 228. Preferably but not exclusively, the material of the chip substrate 228 is a silicon wafer. The insulation material is one selected from the group consisting of field oxide (FOX), silicon dioxide (SiO₂), silicon nitride (Si₃N₄), phosphorus silicon glass (PSG) and a combination thereof.

According to an embodiment of the present disclosure, the heating resistance layer 222 is a resistor material formed on the thermal barrier layer 221. The resistor material one selected from the group consisting of polycrystalline silicon, tantalum aluminide (TaAl), tantalum (Ta), tantalum nitride (TaN), tantalum disilicide (Si₂Ta), carbon (C), silicon carbide (SiC), indium tin oxide (ITO), zinc oxide (ZnO), cadmium sulfide (CdS), hafnium diboride (HfB₂), titanium tungsten (TiW) alloy, titanium nitride (TiN) and a combination thereof.

According to an embodiment of the present disclosure, the conductive layer 223 is a conductive material, and the conductive material is one selected from the group consisting of aluminum (Al), aluminum-copper alloy (AlCu), aluminum-silicon alloy (AlSi), gold (Au), palladium (Pd), palladium-silver alloy (PdAg), platinum (Pt), aluminum-silicon-copper (AlSiCu), niobium (Nb), vanadium (V), hafnium (Hf), titanium (Ti), zirconium (Zr), yttrium (Y) and a combination thereof.

According to an embodiment of the present disclosure, a portion of the protective layer 224 is formed on the heating resistance layer 222, and the other portion of the protective layer 224 is formed on the conductive layer 223. At the same time, the protective layer 224 includes a second protective layer 224B stacked on a first protective layer 224A at the bottom, and a third protective layer 224C stacked on the second protective layer 224B (that is, the stacked order from bottom to top is the first protective layer 224A, the second protective layer 224B and the third protective layer 224C). Preferably but not exclusively, the first protective layer 224A is made of silicon nitride (Si₃N₄) material. The second protective layer 224B is made of a passivation material, and the passivation material is one selected from the group consisting of silicon nitride (Si₃N₄), silicon dioxide (SiO₂), titanium dioxide (TiO₂), hafnium dioxide (HfO₂), zirconium dioxide (ZrO₂), tantalum pentoxide (Ta₂O₅), rhenium heptoxide (Re₂O₇), niobium pentoxide (Nb₂O₅), uranium pentoxide (U₂O₅), tungsten trioxide (WO₃), silicon oxynitride (Si₄O₅N₃), silicon carbide (SiC) and a combination thereof. The third protective layer 224C is made of a metal material, and the metal material is one selected from the group consisting of tantalum (Ta), tantalum nitride (TaN), titanium nitride (TiN), tungsten nitride (TiW) and a combination thereof. In the embodiment, the number and the material of the protective layer 224 can be appropriately adjusted and modified according to the degree of corrosion of the ink on each material, the thermal stress on the entire inkjet chip structure 1 caused by the temperature change during the operation of the heating resistors 222a, and the product life cycle required by inkjet chip structure 1. Similarly, the first protective layer 224A, the second protective layer 224B, and the third protective layer 224C described in the present disclosure are only for illustration and are not intended to limit the scope of rights of the present disclosure. It is explained here in advance.

In the embodiment of the present disclosure, the barrier layer 225 is a polymer material formed on the protective layer 224, and the polymer material is one of polyimide and organic plastic material. In the embodiment, the ink chamber 226 and the ink outlet 227 are integrally formed in the barrier layer 225, and the bottom of the ink chamber 226 is connected to the protective layer 224. The ink outlet 227 is formed on the top of the ink chamber 226, and the ink outlet 227 is in fluid communication with the nozzle aperture 11.

From the above descriptions, the present disclosure provides an inkjet chip structure used in an inkjet cartridge of an inkjet printer. The second control pads of the inkjet chip structure can better withstand the high current required for printing, thereby providing a safer printing environment and preventing the circuit from burning. Meanwhile, the service life of the inkjet chip structure is extended, the printing quality is improved, and multiple colors can be integrated in a single inkjet chip. Moreover, only one set of photomask processes is used, which can improve production efficiency and reduce costs, and solve the problems of traditional separate manufacturing. In addition, the inkjet chip structure of the present disclosure can be manufactured by using a semiconductor process. Consequently, optimizing the nozzle aperture quantity, size, and nozzle plate area ratio of the inkjet chip structure can improve the high-resolution, high-quality image performance of inkjet printing technology, further meeting the cost requirements of various office, commercial, and industrial applications.

While the invention has been described in terms of what is presently considered to be the most practical and preferred embodiments, it is to be understood that the invention is not need to be limited to the disclosed embodiments. On the contrary, it is intended to cover various modifications and similar arrangements included within the spirit and scope of the appended claims so as to encompass all such modifications and similar structures.

What is claimed is:

1. An inkjet chip structure, comprising:
an inkjet chip comprising a plurality of ink supply holes, a plurality of first control pads, a plurality of second control pads, and a plurality of ink droplet generators; and
a nozzle plate disposed on the inkjet chip;
wherein the plurality of first control pads and the plurality of second control pads are disposed on the inkjet chip for receiving inkjet control signals and power signals, respectively, and an area of the plurality of second control pads is equal to or greater than twice of an area of the plurality of first control pads.

2. The inkjet chip structure according to claim 1, wherein the plurality of ink droplet generators have n types, corresponding to different colors in the inkjet chip, and a number of the plurality of ink droplet generators corresponding to each color is greater than or equal to 600, when n=3, the number of the plurality of ink droplet generators is greater than or equal to 1800.

3. The inkjet chip structure according to claim 2, wherein a resolution of the inkjet chip structure is ranged from 150 DPI to 48000 DPI.

4. The inkjet chip structure according to claim 1, wherein the plurality of ink droplet generators have n types, corresponding to different colors in the inkjet chip, and a number of the plurality of ink droplet generators corresponding to each color is greater than or equal to 600, when n=4, the number of the plurality of ink droplet generators is greater than or equal to 2400.

5. The inkjet chip structure according to claim 4, wherein a resolution of the inkjet chip structure is ranged from 150 DPI to 48000 DPI.

6. The inkjet chip structure according to claim 1, wherein the nozzle plate includes a plurality of nozzle apertures, and the ink droplet generators includes a chip substrate, a thermal barrier layer, a heating resistance layer, a conductive layer, a protective layer and a barrier layer, which are stacked sequentially to form a stacked structure, wherein a portion of the conductive layer is formed on the heating resistance layer, a portion of the protective layer is formed on the heating resistance layer, and other potion of the protective layer is formed on the conductive layer, wherein an ink chamber and an ink outlet are integrally formed in the barrier layer, a bottom of the ink chamber is connected to the protective layer, the ink outlet is formed on a top of the ink chamber, and the ink outlet is in fluid communication with the plurality of nozzle aperture.

7. The inkjet chip structure according to claim 6, wherein the thermal barrier layer is made of an insulation material, and the insulation material is one selected from the group consisting of field oxide (FOX), silicon dioxide (SiO2), silicon nitride (Si3N4), phosphorus silicon glass (PSG) and a combination thereof.

8. The inkjet chip structure according to claim 6, wherein the heating resistance layer is made of a resistor material, and the resistor material one selected from the group consisting of polycrystalline silicon, tantalum aluminide (TaAl), tantalum (Ta), tantalum nitride (TaN), tantalum disilicide (Si₂Ta), carbon (C), silicon carbide (SiC), indium tin oxide (ITO), zinc oxide (ZnO), cadmium sulfide (CdS), hafnium diboride (HfB₂), titanium tungsten (TiW) alloy, titanium nitride (TiN) and a combination thereof.

9. The inkjet chip structure according to claim 6, wherein the conductive layer is made of a conductive material, and the conductive material is one selected from the group consisting of aluminum (Al), aluminum-copper alloy (AlCu), aluminum-silicon alloy (AlSi), gold (Au), palladium (Pd), palladium-silver alloy (PdAg), platinum (Pt), aluminum-silicon-copper (AlSiCu), niobium (Nb), vanadium (V), hafnium (Hf), titanium (Ti), zirconium (Zr), yttrium (Y) and a combination thereof.

10. The inkjet chip structure according to claim 6, wherein the barrier layer is made of a polymer material, and the polymer material is one of polyimide and organic plastic material.
